(19) United States
(12) Patent Application Publication
(10) Pub. No.: US 2003/0150091 A1
(43) Pub. Date: Aug. 14, 2003

(54) Foundry rolling unit

(76) Inventors: Thomas Peuker, Baiersdorf-Hagenau (DE); Friedemann Schmid, Erlangen (DE); Uwe Sturmer, Baiersdorf (DE)

Correspondence Address: BAKER BOTTS, LLP, 910 LOUISIANA, HOUSTON, TX, 77002-4995, US

(21) Appl. No.: 10/387,938

(22) Filed: Mar. 12, 2003

Related U.S. Application Data
(63) Continuation of application No. PCT/DE01/03455, filed on Sep. 7, 2001.

(30) Foreign Application Priority Data
Sep. 12, 2000 (DE) 10045085.7

(51) Int. Cl. B23P 23/04

(52) U.S. Cl. 29/33 C

(57) ABSTRACT

The invention relates to a foundry rolling unit, comprising a first production line, with at least one casting machine, the thin slabs of which may be introduced into at least one tunnel furnace, whereby said tunnel furnace opens out into at least one finishing train, with at least one mill stand. After leaving the finishing train the rolled hot strips may be introduced into at least one cooling run and may be rolled on at least one coiler. The foundry rolling unit furthermore comprises a second production line arranged in an at least partly parallel manner in terms of production, with at least one slab introducing device, through which the slabs may be introduced into at least one reheating oven and at least one cogging stand arranged thereafter.

### CROSS-REFERENCE TO RELATED APPLICATION

This application is a continuation of co-pending International Application No. PCT/DE01/03455 filed Sep. 7, 2001, which designates the United States, and claims priority to German application number DE10045085.7 filed Sep. 12, 2000.

### TECHNICAL FIELD

The invention relates to a foundry rolling unit.

### BACKGROUND OF THE INVENTION

In foundry rolling units of this type, thin slabs (thickness of 40 to 90 mm) are processed into strip material, for example. They comprise a casting machine, the thin slabs of which can be fed to at least one tunnel furnace. The tunnel furnace opens out into a finishing train, with at least one mill stand. In the finishing train, the thin slabs are rolled into hot strips. After leaving the finishing train, the rolled hot strips are fed to at least one cooling line and rolled up onto at least one coiler.

DE 195 29 049 is concerned for example with a high-speed thin slabbing unit for producing hot-rolled steel strip from input stock continuously cast in strip form in sequential work steps. In this case, the solidified input stock is divided by means of a strand dividing unit into pre-strip lengths and brought to rolling temperature in an equalizing furnace, pre-rolled in a first rolling mill, used as a roughing train, and after intermediate storage in winding-up and unwinding stations arranged upstream of the finishing train, is fed to the finishing train for rolling down to finished strip thickness.

Known units are particularly economical by virtue of their compact design (low investment and operating costs). However, the production of stainless steels and high-alloyed steels entails difficulties in terms of castability. On account of the instability during casting, the casting rate is relatively low. When continually changing between stainless steels, high-alloyed steels and carbonaceous steels, under some circumstances problems occur in the operation of the finishing train and consequently in the quality of the finished strip material.

JP-A-57-146404 discloses a hot rolling train in which a finishing mill train is fed rolling stock to be unwound from coils, it being possible for the rolling stock to originate from two different casting devices, slabs being initially cut after casting, then fed to a furnace and rolled if appropriate. When leaving one of the casting devices, the rolling stock is wound up in the form of coils and only subsequently transported to the finishing train and then unwound again.

It is therefore the object of the present invention to provide a foundry rolling unit which permits a wide product spectrum, in particular the production of various types of steel, including stainless steels and high-alloyed steels of various thicknesses, whilst achieving a correspondingly high throughput.

The object is achieved according to the invention by a foundry rolling unit with the features of claim 1. Advantageous refinements of this foundry rolling unit are respectively the subject of further claims.

### SUMMARY OF THE INVENTION

It is therefore the object of the present invention to provide a foundry rolling unit which permits a wide product spectrum, in particular the production of various types of steel, including stainless steels and high-alloyed steels of various thicknesses, whilst achieving a correspondingly high throughput.

The object is achieved according to the invention by a foundry rolling unit with the features: a first production line with at least one casting machine, the thin slabs of which can be fed to at least one tunnel furnace, the tunnel furnace opening out into at least one finishing train with at least one mill stand, and, after leaving the finishing train, the rolled hot strips being able to be fed to at least one cooling line and rolled up onto at least one coiler; a second production line, arranged in an at least partly parallel manner in terms of production, with at least one slab feeding device, by which the slabs can be fed to at least one reheating furnace, and at least one cogging stand arranged downstream thereof, and the rolled pre-strips being able to be accepted as coils by at least one coil box; and a coil transporting device, by which the coils can be transferred before the finishing train from the second production line into the first production line, the coils being able to be removed from the coil box and transported to the input of the finishing train for the feeding of the pre-strips. Advantageous refinements of this foundry rolling unit are respectively the subject of the following description.

The foundry rolling unit according to the invention comprises at least a first production line with at least one casting machine, the thin slabs of which can be fed to at least one tunnel furnace, the tunnel furnace opening out into at least one finishing train with at least one mill stand, and, after leaving the finishing train, the rolled hot strips being able to be fed to at least one cooling line and rolled up onto at least one coiler. This permits low-cost production of ultra-thin hot strip.

The foundry rolling unit of the present invention, may further comprise a second production line, arranged in an at least partly parallel manner in terms of production, with at least one slab feeding device, by which the slabs can be fed to at least one reheating furnace, and at least one cogging stand arranged downstream thereof, and the rolled pre-strips being able to be accepted as coils by at least one coil box.

The foundry rolling unit according to the invention further comprises a coil transporting device, by which the coils can be transferred before the finishing train from the second production line into the first production line, the coils being able to be removed from the coil box and transported to the input of the finishing train for the feeding of the pre-strips.

By these measures it is possible with the foundry rolling unit of the present invention to produce a complete production spectrum of extremely different types of steel, in particular including stainless steel and high-alloyed steel, whilst achieving a correspondingly high throughput.

In the case of an advantageous refinement, the coil box is assigned at least one holding furnace for keeping at least one coil. According to an alternative embodiment, the coil box is heatable. It is possible within the scope of the invention to extend the foundry rolling unit by adding a slab producing device. In this case, the slab producing device is arranged upstream of the slab feeding device as a component part of the second production line.

According to a refinement of the present invention, the slabs produced by the slab producing device can be fed directly to the slab feeding device (hot charging) and/or, according to a refinement, they can be buffered in terms of production in a store and fed to the slab feeding device as and when required (cold charging).

Furthermore, it is alternatively or additionally possible, as described, for slabs produced elsewhere to be fed to the slab feeding device (cold charging). It is possible by the refinements described to adapt the foundry rolling unit according to the invention in a simple way to the production requirements.

### BRIEF DESCRIPTION OF THE FIGURE

FIG. 1 shows an exemplary embodiment of the invention.

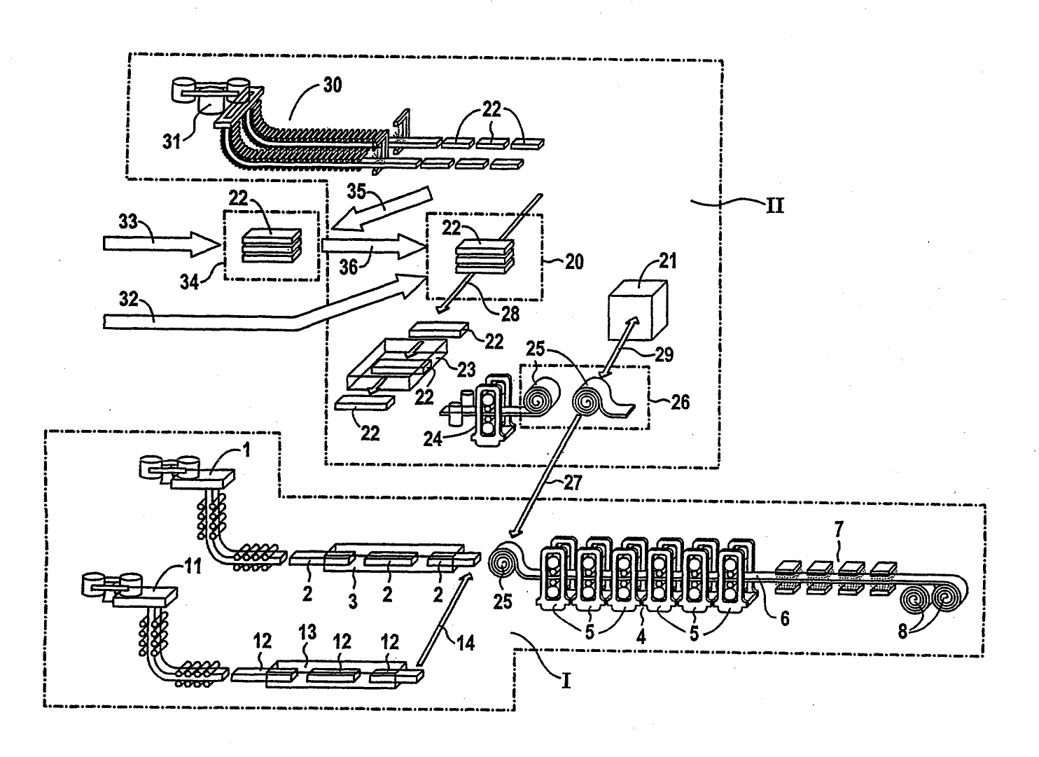

### DETAILED DESCRIPTION OF THE PREFERRED EMBODIMENTS

In the drawing, a first production line is designated by I. The first production line I comprises a casting machine 1, in which thin slabs 2 are cast. These thin slabs 2 are fed to a tunnel furnace 3. The tunnel furnace 3 opens out into a finishing train 4, which in the exemplary embodiment represented has six mill stands 5. In the finishing train 4, the thin slabs 2 are rolled into hot strips 6. After leaving the finishing train 4, the rolled hot strips 6 are fed to a cooling line 7 and rolled up onto a coiler 8.

In the case of the embodiment of the foundry rolling unit represented in the drawing, as a first extension, a further casting machine 11 is arranged in the first production line I. The casting machine 11 is arranged in a parallel manner in terms of production in relation to the casting machine 1. The casting machine 11 likewise produces thin slabs 12. These thin slabs 12 are fed to a tunnel furnace 13, which is arranged in a parallel manner in terms of production in relation to the tunnel furnace 3 within the first production line I. The thin slabs 12 are subsequently likewise fed to the finishing train 4 (arrow 14).

According to the invention, a second production line II is arranged in an at least partly parallel manner in terms of production in relation to the first production line I. In the exemplary embodiment represented, the second production line II comprises a slab feeding device 20. By this slab feeding device 20, the slabs 22 can be fed to a reheating furnace 23 and a downstream (reversing) cogging stand 24. The pre-strips rolled in the cogging stand 24 are accepted as coils 25 by a coil box 26.

According to the invention, the foundry rolling unit further comprises a coil transporting device, by which the coils 25 are transferred before the finishing train 4 from the second production line II into the first production line I. The coil transporting device is not represented in the drawing for reasons of overall clarity. For feeding the pre-strips, the coils 25 are removed from the coil box 26 and transported to the input of the finishing train 4. The feeding of the coils 25 is symbolized by an arrow 27.

In the case of the refinement represented in the drawing, the coil box 26 is assigned a holding furnace 21 for keeping the coils (double-headed arrow 29).

In addition, the embodiment shown is extended by adding a slab producing device 30. The slab producing device 30 is in this case arranged upstream of the slab feeding device 20. The slab producing device 30 comprises a casting machine 31, in which slabs 22 are cast. These slabs 22 are fed directly to the slab feeding device 20 (hot charging). The slab feeding device 20 in turn feeds the slabs 22 to the reheating furnace 23 (arrow 28).

Alternatively, in the case of the embodiment represented in the drawing, slabs produced elsewhere may be fed to the slab feeding device 20 (cold charging). The feeding of the slabs produced elsewhere is symbolized by an arrow 32.

Both the slabs 22 produced by the slab producing device 30 and the slabs produced elsewhere may be buffered in terms of production in a store 34 (arrow 33 or arrow 35) and fed to the slab feeding device 20 as and when required (arrow 36, cold charging).

What is claimed is:

1. A foundry rolling unit, which comprises the following features:
a first production line with at least one casting machine, the thin slabs of which can be fed to at least one tunnel furnace, the tunnel furnace opening out into at least one finishing train with at least one mill stand, and, after leaving the finishing train, the rolled hot strips being able to be fed to at least one cooling line and rolled up onto at least one coiler,
a second production line, arranged in an at least partly parallel manner in terms of production, with at least one slab feeding device, by which the slabs can be fed to at least one reheating furnace, and at least one cogging stand arranged downstream thereof, and the rolled pre-strips being able to be accepted as coils by at least one coil box,
a coil transporting device, by which the coils can be transferred before the finishing train from the second production line into the first production line, the coils being able to be removed from the coil box and transported to the input of the finishing train for the feeding of the pre-strips.

2. The foundry rolling unit as claimed in claim 1, which comprises the following further feature:
the coil box is assigned at least one holding furnace for keeping at least one coil.

3. The foundry rolling unit as claimed in claim 1, which comprises the following further feature:
the coil box is heatable.

4. The foundry rolling unit as claimed in claim 1, which comprises the following further feature:
the second production line has a slab producing device, which is arranged upstream of the slab feeding device.

5. The foundry rolling unit as claimed in claim 4, which comprises the following further feature:
the slabs produced by the slab producing device can be fed directly to the slab feeding device.

6. The foundry rolling unit as claimed in claim 4, which comprises the following further feature:
the slabs produced by the slab producing device are buffered in terms of production in a store and can be fed to the slab feeding device as and when required.

7. The foundry rolling unit as claimed in claim 1, which comprises the following further feature:
slabs produced elsewhere can be fed to the slab feeding device.

8. A foundry rolling unit comprising:
a first production line comprising,
at least one casting machine for the production of slabs,
a tunnel furnace for receipt of slabs from the casting machine,
a finishing train for receipt of slabs from the tunnel furnace, said train having at least one mill stand,
a cooling line for receipt of slabs from the finishing train, said cooling line capable of feeding at least one coiler,
a second production line, arranged in an at least partly parallel manner with the first production line in terms of production, said line comprising,
at least one slab feeding device,
a reheating furnace for receipt of slabs from the feeding device,
at least one cogging stand arranged downstream of the reheating furnace, and
at least one coil box
the unit further comprising a coil transporting device to transfer coils from the second production line into the first production line.

9. The foundry rolling unit as claimed in claim 8, wherein the coil box is assigned at least one holding furnace for keeping at least one coil.

10. The foundry rolling unit as claimed in claim 8, wherein the coil box is heatable.

11. The foundry rolling unit as claimed in claim 8, wherein the second production line further comprises a slab producing device arranged upstream of the slab feeding device.

12. The foundry rolling unit as claimed in claim 11, wherein the slabs produced by the slab producing device is adapted to feed slabs directly to the slab feeding device.

13. The foundry rolling unit as claimed in claim 11, further comprising a store downstream of the slab producing device.

14. The foundry rolling unit as claimed in claim 8, wherein the slab feeding device is adapted to receive slabs produced from another production line.
